(19) United States
(12) Patent Application Publication
(10) Pub. No.: US 2024/0271957 A1
(43) Pub. Date: Aug. 15, 2024

(54) COMPUTER-IMPLEMENTED METHOD AND SYSTEM FOR ANALYZING THE BEHAVIOR OF A PARTICIPANT IN A TRAFFIC SCENE

(71) Applicant: Robert Bosch GmbH, Stuttgart (DE)

(72) Inventors: Faris Janjos, Stuttgart (DE); Felicia Ruppel, Renningen (DE); Maxim Dolgov, Renningen (DE); Yinzhe Shen, Karlsruhe (DE)

(21) Appl. No.: 18/429,057

(22) Filed: Jan. 31, 2024

(30) Foreign Application Priority Data
Feb. 14, 2023 (DE) 10 2023 201 197.2

(51) Int. Cl. G01C 21/00

(52) U.S. Cl. CPC G01C 21/3811

(57) ABSTRACT

A computer-implemented method analyzing the behavior of a participant in a traffic scene. In the method, the participant is detected on the basis of aggregated scene-specific information in the traffic scene. At least one past track profile for the participant is reconstructed on the basis of the scene-specific information aggregated at a current point in time, by generating perception results for a sequence of points in time in the past.

### CROSS REFERENCE

The present application claims the benefit under 35 U.S.C. § 119 of German Patent Application No. DE 10 2023 201 197.2 filed on Feb. 14, 2023, which is expressly incorporated herein by reference in its entirety.

### BACKGROUND INFORMATION

The present invention relates to a computer-implemented method for analyzing the behavior of at least one participant in a traffic scene and to a computer-implemented system for carrying out such a method.

To realize automated driving functions, methods based on deep learning (DL) are often used for the perception of traffic scenes and the prediction of the future development of traffic scenes. For the perception, models are used that combine scene-specific information from a wide variety of information sources in order to detect objects and to extract information about these currently “perceived” objects. The perception result can be made available, for example, in the form of bounding boxes comprising information relating to the dimensions, position and orientation and relating to the movement state of a detected object. For the prediction, models that generate possible future trajectories for the individual detected objects are often used.

In the conventional methods for perception and prediction, a distinction is made between methods without online tracking and methods with online tracking, wherein tracking is understood to mean the following of an object over time. Generally, not only the traveled trajectory of the object is considered, but also additional information, such as changes in the orientation and the movement state of the object.

In the methods without online tracking, the following of the objects over time is carried out offline. Only after the prediction of the future movement of a detected object does a tracker put the perception results, e.g. bounding boxes, generated for this object at multiple points in time in the past into a temporal context, thus generating a track profile.

Since the track profile is ascertained only after the prediction, only the current perception result for the prediction can be used, but not additional information of the track profile, such as the change over time in pose, speed, acceleration and/or rotation rate of the object.

In methods with online tracking, however, it is also possible to use information from further in the past for the prediction.

A first method with online tracking uses a traditional tracker with explicit association, i.e., newly detected objects are each associated with an existing track or start a new track.

In Liang et al., “PnPNet: End-to-End Perception and Prediction with Tracking in the Loop,” https://arxiv.org/abs/2005.14711, a specific neural network is described, which encodes past trajectories and observations together. This representation is referred to as “trajectory level object representation” and is used both in the tracking and in the prediction. Here, the process is performed sequentially, i.e., detection first, then tracking and then prediction. This means that the prediction is based on the past state as well as the current state.

In Weng et al., “PTP: Parallelized Tracking and Prediction with Graph Neural Networks and Diversity Sampling,” https://arxiv.org/abs/2003.07847v2, tracking and prediction are parallelized. An LSTM (long short-term memory) is used in order to aggregate past information, and therefore tracking errors in the past cannot be rectified. Instead, these tracking errors persist in each further tracking step.

A second method with online tracking uses a transformer-based architecture with detector and tracker. Here, in each time step under consideration, a certain number of object and track queries is input into the model, in addition to the aggregated scene-specific information, such as sensor data. For each of these queries, a set of latent features is generated, namely a so-called feature vector, which stands for the option of detecting an object or continuing the track of an already detected object. The transformer model thus delivers exactly as many feature vectors as queries that were input into the model.

In Gu et al., “ViP3D: End-to-end Visual Trajectory Prediction via 3D Agent Queries,” https://arxiv.org/abs/2208.01582, the output feature vectors of the transformer are used directly as a representation of the past state of an object. No additional encoding of the past states is necessary here.

### SUMMARY

The present invention improves the analysis of the behavior of participants in a traffic scene by adapting the tracking of at least one participant also retroactively to a state of the participant detected at the current point in time.

For this purpose, at least one participant is first detected in the traffic scene on the basis of aggregated scene-specific information. According to an example embodiment of the present invention, at least one past track profile for the participant is then reconstructed on the basis of the scene-specific information aggregated at a current point in time, by generating perception results for a sequence of points in time in the past.

Accordingly, an example embodiment of the present invention therefore includes reconstructing the past track profile on the basis of the scene-specific information aggregated at the current point in time, i.e., sensor data from the vehicle and from outside the vehicle, map information, GPS data, etc., instead of continuing an existing track profile simply by adding the current perception result, or applying a new track or deleting an existing track.

The use of the scene-specific information aggregated at the current point in time for the reconstruction of the track profile in the past is also referred to as smoothing. It is thereby ensured that the current perception result always also acts retroactively on the entire track profile, and the output track profile becomes increasingly better, i.e., the reconstructed track profile corresponds increasingly better to the actual track profile of the observed participant. In addition, it can be ensured by the smoothing that the output track profiles are free of gaps.

These effects prove to be advantageous in particular for downstream components, such as separate prediction and planning modules, if these also use multiple past states of a participant as input in addition to the current perception result.

The perception result at a given point in time describes the status of the participant at this point in time. Depending on the application, the perception result can comprise more or less and also different information. Advantageously, according to an example embodiment of the present invention, the perception result comprises location information and/or movement information of the participant for a given point in time, in particular information about the position, orientation, speed, acceleration and/or rotation rate of the participant. A preferred representation form for perception results are so-called bounding boxes, which additionally also comprise information about the dimensions of the participant.

The method according to the present invention can advantageously be extended by the prediction of at least one possible future trajectory of the participant by additionally generating, on the basis of the scene-specific information aggregated at the current point in time, perception results for a sequence of points in time in the future. In this case, tracking and prediction are thus integrated in one method. Advantageously, a possibility of combining the past track profile and the future trajectory of the participant is taken into account in the process. Overall, the prediction is thereby more robust with respect to tracking errors. For example, if the currently estimated orientation of a tracked object deviates from the current direction of travel of the object due to a measurement outlier, this can lead, in particular in the case of predictors with a dynamic model, to the prediction of a departure of the object from the road, although this is not possible due to the actual orientation and direction of travel of the object. Such negative influences of measurement outliers can be reduced by the smoothing effect.

Both the reconstruction of the track profile and the prediction of a possible future trajectory for the participant are generally limited to a predefined number of consecutive points in time in the past or in the future, so that the time window under consideration always covers a predefined time period around the current point in time and continues to move as time progresses. The relevant sequence of points in time can comprise the current point in time or follow the current point in time, but this does not necessarily have to be the case. Usually, reconstructed track profiles comprise 2 to 3 seconds, i.e., 5 to 8 consecutive points in time depending on the sampling rate, while the prediction is usually carried out for 6 to 8 seconds, i.e., for 12 to 16 consecutive points in time depending on the sampling rate.

A deep learning (DL) architecture is advantageously used for realizing the method according to an example embodiment of the present invention. The scene-specific information aggregated at a given point in time is thus mapped onto at least one set of latent features. The perception result for the participant and the given point in time is then ascertained on the basis of the set of latent features generated in this way. According to the present invention, at least one past track profile of the participant is also reconstructed and/or at least one possible future trajectory is predicted for the participant.

The method according to the present invention described above is preferably implemented with the aid of a computer-implemented system for analyzing the behavior of at least one participant in a traffic scene, which system comprises an input stage for aggregating scene-specific information at a given point in time and a predictor which is designed for the prediction of at least one possible future trajectory for the participant, wherein the prediction takes place on the basis of the scene-specific information aggregated at a current point in time. According to the present invention, the predictor is also designed to reconstruct at least one past track profile for the participant on the basis of the scene-specific information aggregated at the current point in time.

As already indicated above, in a preferred embodiment of the present invention, the system has a DL architecture. In this case, the input stage comprises a first trained neural network, which generates at least one set of latent features for the participant on the basis of scene-specific information aggregated at a given point in time. The predictor comprises a second trained neural network, which, using the set of latent features generated by the input stage, reconstructs at least one past track profile for the participant and/or predicts at least one possible future trajectory for the participant.

With regard to the quality of the reconstructed track profiles, i.e., the correspondence with the actual track profile of the participant, and the quality or robustness of the prediction, it proves to be extremely advantageous to train the first neural network of the input stage and the second neural network of the predictor together. In this case, in the training, both the error between ground truth and smoothed track profiles and the error between ground truth and predicted trajectories are back-propagated to the input stage. In this way, the input stage is explicitly trained to aggregate information about the history of tracks in the output feature set, i.e., the sets of latent features output by the input stage are explicitly trained to accumulate information about the history of tracks. In this way, the reconstruction of track profiles is improved by, for example, being able to correct track breaks. However, this information is also available for the prediction and can improve this. Therefore, the first neural network of the input stage advantageously has aggregated information about the history of track profiles by jointly training with the second neural network of the predictor.

### BRIEF DESCRIPTION OF THE DRAWINGS

The measures according to the present invention and preferred implementation options are explained in more detail below with reference to the figures.

FIGS. 1A to 1C illustrate the mode of operation of the method according to the present invention on the basis of a comparison between the results of the method according to the present invention and a tracking and prediction according to the related art.

FIG. 2 shows a schematic representation of a computer-implemented system according to an example embodiment of the present invention for analyzing the behavior of a participant in a traffic scene.

### DETAILED DESCRIPTION OF EXAMPLE EMBODIMENTS

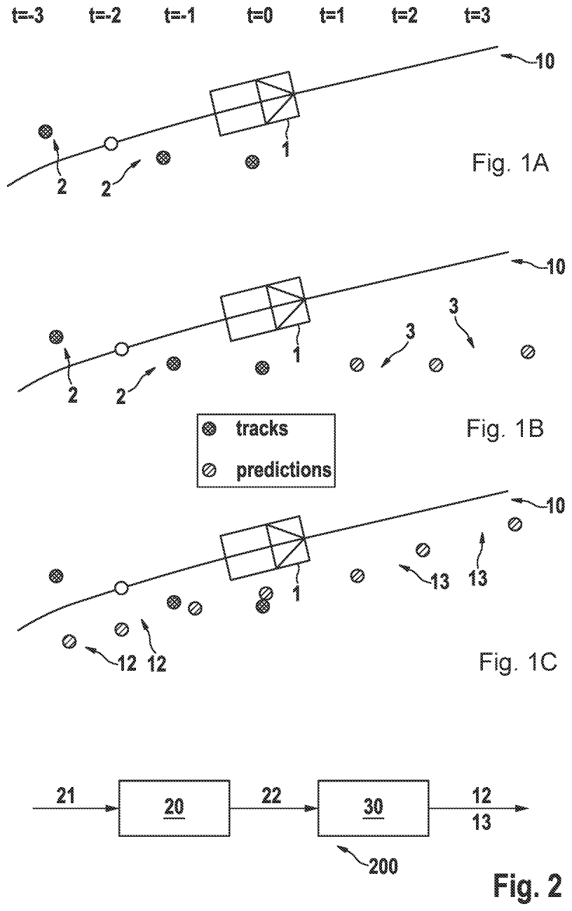

FIGS. 1A to 1C each show the actual course 10 of a traffic participant 1 over a predefined time period. This time period comprises a total of seven detection or sampling points in time at a time interval of 200 ms, namely three points in time in the past t=−3, t=−2, t=−1, the current point in time t=0, and three points in time in the future t=1, t=2, t=3. The participant 1 is shown here as a so-called bounding box. The bounding box represents information about the state of the participant 1. This state information was ascertained on the basis of scene-specific information that was aggregated at the current point in time t=0. Scene-specific information that has been aggregated over a predefined period up to the current point in time can also be taken into account. The scene-specific information can be sensor data that have been detected by a sensor system belonging to the vehicle and/or external to the vehicle, possibly in conjunction with map information, GPS data, weather data, etc. According to the representation in FIGS. 1A-1C, the bounding box comprises information about the location or the position of the participant 1, information about the dimensions of the participant and its orientation or spatial alignment. Furthermore, the bounding box can also comprise movement information, such as information about the speed, acceleration, and rotation rate of the participant 1. In any case, in all three FIGS. 1A, 1B and 1C, the bounding box represents the perception result for the participant 1 at the current point in time t=0. In the following, it is assumed that the state information of the current perception result is correct.

FIG. 1A shows a track profile 2 of the participant 1 that was ascertained according to a conventional method. This track profile 2 consists of the sequence of perception results, shown here as crosshatched points, that were ascertained at the points in time t=−3, t=−2, t=−1 and t=0. Here, the current perception result for t=0 was only added to the already existing track profile 2, while the perception result for t=-4 (not shown here) was removed. The remaining perception results for t=−3, t=−2 and t=−1 were retained unchanged. A correction of the obviously erroneous track profile 2 was not carried out.

FIG. 1B shows, in addition to the track profile 2 from FIG. 1A, a future trajectory 3 for the participant 1 that has been predicted on the basis of the erroneous track profile 2. This trajectory 3 consists of a sequence of perception results, shown here as circular points, that were generated for the points in time t=1, t=2 and t=3. Despite the correct perception result for t=0, the prediction here accepts the obviously erroneous orientation or direction of travel of the track profile 2.

FIG. 1C shows, in addition to the track profile 2 from FIG. 1A, the result of the method according to the present invention, specifically in the form of a sequence of filled points. These points represent perception results that have been generated on the basis of the scene-specific information aggregated at the current point in time t=0, specifically as a reconstruction of the track profile 12 in the past for the points in time t=−3, t=−2 and t=−1, and as a prediction of a future trajectory 13 of the participant for the points in time t=1, t=2 and t=3. The fusing according to the present invention of tracking and prediction makes it easier for the reconstructed track profile 12 and the predicted trajectory to be combined with one another.

FIG. 1C also shows that erroneous perception results in the track profile are smoothed, i.e., subsequently compensated for at least partially, by the method according to the present invention, which in the present case also has a favorable effect on the prediction.

As already mentioned, the method according to the present invention can in principle be realized with the aid of any DL architecture.

In the following, a possibility is described that is based on the use of a transformer-based tracker as described in Gu et al., “ViP3D: End-to-end Visual Trajectory Prediction via 3D Agent Queries.” Such a tracker outputs a sequence of feature vectors, i.e., sets of latent features, for a traffic scene so that one feature vector is present per object or participant in the traffic scene and per time step. Gu et al. then only uses the current feature vector of a tracked object as an input for a predictor, which thus predicts the future positions or states of the tracked objects. The prediction takes place iteratively, starting with the position, currently known from the tracker, of the bounding box of the relevant object.

The method according to the present invention uses the current feature vector supplied by the tracker and the predictor for reconstructing the past track profile of a participant. At this point, it should be noted that the reconstruction according to the present invention of the past track profile can take place completely independently of a prediction of possible future trajectories or else together with such a prediction. In any case, the predictor generates a track profile for the past on the basis of the current feature vector. In this way, the past track profile is updated with currently available information. This smoothing improves the history of the track. The performance of downstream components, such as prediction and planning, can thereby be increased.

In FIG. 2, the essential components of a computer-implemented system 200 according to the present invention for analyzing the behavior of a road user are schematically shown. The system 200 comprises an input stage 20, which aggregates scene-specific information 21 from different information sources belonging to the vehicle and possibly also external to the vehicle. The scene-specific information 21 is generally data that are detected by camera, lidar and/or radar sensors. Inertial sensors can also be used for aggregating scene-specific information 21. The scene-specific information 21 is also often supplemented by GPS and map data, as well as weather data and data relating to the state of the road. The aggregation of the scene-specific information 21 takes place at a given point in time. In general, the scene-specific information aggregated at a given point in time comprises the sensor data and other data that are current at this point in time. However, the scene-specific information aggregated at a given point in time can also comprise sensor data and other data that have been collected over a predefined time period up to the given point in time.

The input stage 20 comprises a trained neural network, which generates at least one set of latent features 22 for the participant on the basis of the scene-specific information 21 for the given point in time. This first neural network is not shown in detail here.

The set of latent features 22 is supplied as input to a predictor 30, which also comprises a trained neural network. This second neural network is also not shown here. The neural network of the predictor 30 predicts at least one possible future trajectory 13 for the participant using the set of latent features 22 generated by the input stage 20. This prediction always takes place on the basis of the scene-specific information 21 aggregated at a current point in time.

According to the present invention, the predictor 30 is also designed to reconstruct at least one past track profile 12 for the participant on the basis of the scene-specific information 21 aggregated at the current point in time. For this purpose, the neural network of the predictor 30 also uses the set of latent features 22 generated by the input stage 20.

Advantageously, the first neural network of the input stage 20 and the second neural network of the predictor 30 are trained together, so that the input stage 20 can aggregate information about the history of track profiles in the past and in the future.

Both for reconstruction of track profiles and for the prediction of trajectories, the predictor 30 in each case generates a sequence of perception results. For this purpose, reference is made to the explanations relating to FIGS. 1A to 1C.

What is claimed is:

1. A computer-implemented method for analyzing a behavior of at least one participant in a traffic scene, the method comprising the following steps:
detecting the participant based on aggregated scene-specific information in the traffic scene;
reconstructing at least one past track profile for the participant based on the scene-specific information aggregated at a current point in time, by generating perception results for a sequence of points in time in the past.

2. The method according to claim 1, wherein each perception result includes location information and/or movement information of the participant for a given point in time, including information about a position and/or dimensions and/or orientation and/or speed and/or acceleration and/or rotation rate of the participant.

3. The method according to claim 1, wherein at least one possible future trajectory for the participant is predicted based on the scene-specific information aggregated at the current point in time, by generating perception results for a sequence of points in time in the future.

4. The method according to claim 3, wherein a possibility of combining the past track profile and the future trajectory of the participant is taken into account in the reconstruction and the prediction.

5. The method according to claim 1, wherein the at least one track profile of the participant is reconstructed for a predefined first number of points in time in the past and/or in that the at least one possible trajectory of the participant is predicted for a predefined second number of points in time in the future.

6. The method according to claim 1, wherein a deep learning architecture is used to:
a. map the scene-specific information aggregated at a given point in time onto at least one set of latent features,
b. ascertain the perception result for the participant and the given point in time based on the set of latent features, and
c. reconstruct at least one past track profile of the participant and/or predict at least one possible future trajectory for the participant.

7. A computer-implemented system for analyzing a behavior of at least one participant in a traffic scene, the system comprising:
a. an input stage configured to aggregate scene-specific information at a given point in time; and
b. a predictor configured to predict at least one possible future trajectory for the participant, wherein the prediction takes place based on the scene-specific information aggregated at a current point in time;
wherein the predictor is also configured to reconstruct at least one past track profile for the participant based on the scene-specific information aggregated at the current point in time.

8. The system according to claim 7, wherein the input stage includes a first trained neural network, which generates at least one set of latent features for the participant based on scene-specific information aggregated at the given point in time.

9. The system according to claim 8, wherein the predictor includes a second trained neural network, which, using the set of latent features generated by the input stage, reconstructs at least one past track profile for the participant and/or predicts at least one possible future trajectory for the participant.

10. The system according to claim 8, wherein the first neural network of the input stage has aggregated information about the history of track profiles by jointly training with a second neural network of the predictor.
